(19) United States
(12) Patent Application Publication
(10) Pub. No.: US 2007/0296559 A1
(43) Pub. Date: Dec. 27, 2007

(54) VEHICLE-BASED CONTROL OF A HAND-HELD COMMUNICATION DEVICE

(75) Inventor: WALTON L. FEHR, MUNDELEIN, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 11/426,351

(22) Filed: Jun. 26, 2006

(51) Int. Cl. B60R 25/10

(52) U.S. Cl. 340/426.2; 340/438

(57) ABSTRACT

A system and method for controlling a hand-held communication device in a vehicle is disclosed. In an embodiment of the invention, the hand-held communication device is controlled by a driver advocate or workload manager module. To control the cellular telephone, at least a transmitter is coupled to the diagnostic connector (e.g., an OBD-II connector) in the vehicle, which can be coupled directly to the connector via a dongle or can be coupled via a cable. The transmitter receives instructions from the workload manager module and transmits them to the cellular telephone, preferably via a short-range wireless protocol such as Bluetooth, although fully wired links can also be used as well. So that the cellular telephone can properly interpret and act on these commands, an application program (e.g., a Java applet) is preferably downloaded to the telephone through any suitable means. With the application program in place in the telephone, the commands from the workload manager module or other controlling module in the vehicle can now be implemented at the cellular telephone, thus providing safety and convenience benefit to the vehicle's user.

### FIELD OF THE INVENTION

This invention generally relates to organizing and controlling communications in a vehicle, and particularly to controlling a hand-held communication device in a vehicle.

### BACKGROUND

Modern-day vehicles contain specialized communication systems known as telematics systems. Telematics systems essentially provide communicative intelligence for the vehicle. For example, and as shown in FIG. 1, telematics unit 10 in vehicle 8 contains an embedded cellular telephone device 12 (analogous to a hand-held cellular telephone) which allows the vehicle and its users the ability to communicate with systems and other users outside of the vehicle. Thus, the user interface 15 in the vehicle 8 might comprise at least one speaker 16 (typically, the same speaker(s) used for the vehicle's radio) and at least one microphone 17. This allows a user in the vehicle 8 (i.e., the driver or a passenger) to use the embedded device 12 to make and receive telephone calls. Moreover, the user interface 15 in the vehicle might contain other devices such as a display (not shown), and/or a keypad interface (not shown) which would allow the user to make calls on the embedded device. The embedded device 12 may also transmit and receive non-voice data, such as mapping data from an off-vehicle mapping system (not shown), which could be shown on the display of the user interface 15.

As well as being coupled to the “outside world” via the embedded communication device 12, telematics units 10 are normally also coupled to a vehicle bus 14. The vehicle bus 14 is normally coupled to many other subsystems in the vehicle 8, such as the engine controller 22, the turn signal controller 24, the controller for the door locks and windows 26, the on-board diagnostic (ODB) system 28 which communicates with various vehicular sensors, a Global Position System (GPS) module 30, etc. Of course, many other types of devices or subsystems will normally couple to the vehicle bus 14, although they are not shown in FIG. 1 for simplicity. In any event, by having the telematics unit 10 and other subsystems 22-30 coupled to the vehicle bus 14, relevant data can be communicated to and from the subsystems 22-28.

In has also been proposed to provide a driver advocate™ module 32 in a vehicle, which can generically be referred to as a workload manager module 32. The role of the workload manager module 32 is to review the various signals on the vehicle bus 14 to try and discern the basic level of “stress” that the user (driver) might be under, and to adjust potentially-distracting communications to the driver accordingly. The basic principle of the workload manager module 32 is to run an algorithm to prohibit unnecessary interruptions to the driver when it is clear to the module 32 that the driver is busy. In a simple example, if the workload manager module 32 understands from vehicle bus 14 that turn signal controller 24 is issuing a turn signal, the module 32 might infer that the driver is currently busy and should not be interrupted except in the most exigent of circumstance (for example, when called by certain people designated by the user as very important). Thus, the workload manager module 32 might decide during issuance of a turn signal that the driver not receive cellular telephone calls from the embedded device 12, and accordingly that such in-coming calls should be immediately routed to a voice mailbox. Otherwise, the workload manager module 32 might mandate that a less-intrusive manner of notifying the user of the call (rather than a ring) might be implemented by the embedded device 12. Of course, the algorithm operating in the workload manager module 32 would normally be much more complicated than these simple examples illustrate, but the basic point is that the workload manager module 32 can infer via communications on the vehicle bus 14 how busy the driver might be, and accordingly can control or arbitrate communications to the driver depending on the level of distraction. Further details concerning the operation of a workload manager system can be found in U.S. Ser. No. 10/972,737, which is hereby incorporated by reference.

The system of FIG. 1 is certainly beneficial and provides substantial safety improvements through use of the workload manager module 32 control of the telematics unit 10 (which de facto controls the embedded communication device 12 and the user interface 15). However, the benefits of that system are effectively lost when different, uncontrolled communication devices are brought into the system's environment. For example, it is commonplace for users in vehicles to have their own personal hand-held communication devices 40, such as cellular telephones, Personal Data Assistants, portable computers, etc. (For convenience, the remainder of this disclosure refers to a cellular telephone 40, although as just noted, other like hand-held communication devices can also be used). Of course, such devices 40 are outside of the reach of the workload manager module 32. The effect is that a user may be very busy driving the vehicle, something which the workload manager module 32 will understand via the signaling on the vehicle bus 14. Yet, the user will still receive disruptive calls on his cellular telephone 40 at inappropriate times.

When it is considered that most persons having vehicles with telematics unit 10 generally also have their own personal hand-held communication devices, it is apparent that a solution to this problem is warranted. Moreover, such a solution is preferably after-market, i.e., able to be easily implemented on any telematics system and/or the cellular telephone 40 after manufacture of those devices are complete.

### BRIEF DESCRIPTION OF THE DRAWINGS

Embodiments of the inventive aspects of this disclosure will be best understood with reference to the following detailed description, when read in conjunction with the accompanying drawings, in which:

FIG. 1 illustrates a communication system within a vehicle in the prior art, including the provision of a telematics unit and a workload manager module coupled to a vehicle bus;

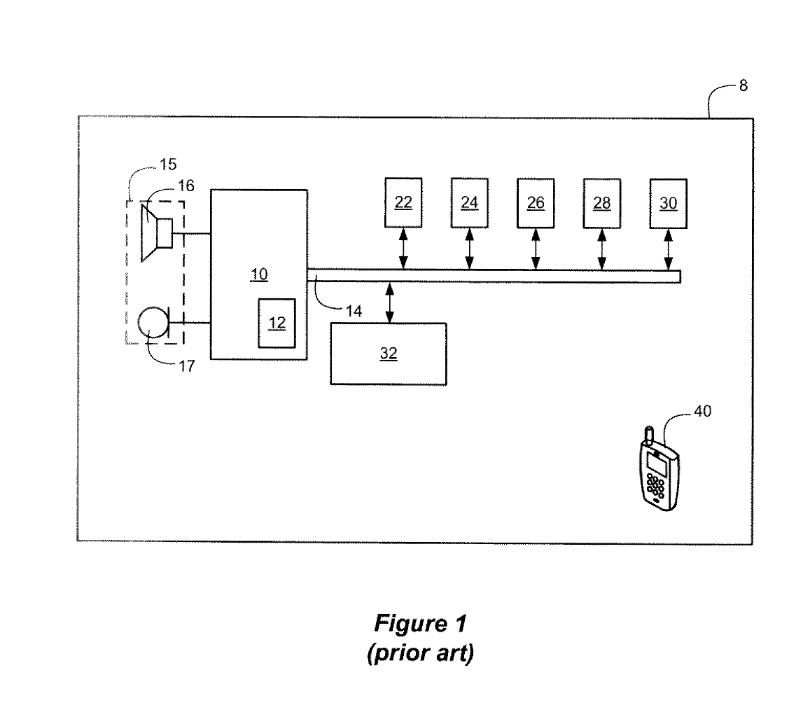

FIG. 2 illustrates a communication system within a vehicle in accordance with an embodiment of the invention, including provision of a short-range transmitter “dongle” coupled to a diagnostic connector and capable of communicating with and controlling a hand-held communication device;

FIG. 3 illustrates further details of the internal circuitry of the dongle and hand-held communication device of FIG. 2 to better illustrate operation of embodiments of the invention;

FIG. 4 illustrates another embodiment of a communication system in which the transmitter device of FIG. 2 is coupled to the diagnostic connector by a cable; and

FIG. 5 illustrates yet another embodiment of a communication system in which the hand-held communication device is directly coupled to the diagnostic connector by a cable.

### DETAILED DESCRIPTION

A system and method for controlling a hand-held communication device in a vehicle is disclosed. In an embodiment of the invention, the hand-held communication device (e.g., a cellular telephone) is controlled by a workload manager module, just as the embedded communication device in the telematics unit is controlled by the workload manager module as discussed above. To control the cellular telephone, at least a transmitter is coupled to the diagnostic connector (e.g., an OBD-II connector) in the vehicle. That transmitter can be coupled directly to the connector via a dongle or can be coupled via a cable. Either way, the transmitter receives instructions from the workload manager module and transmits them to the cellular telephone, for example, via a short-range wireless protocol such as Bluetooth, or WiFi, or any other suitable protocol. So that the cellular telephone can properly interpret and act on these commands, an application program (e.g., a Java applet) is preferably downloaded to the telephone either through the cellular telephone's multi-pin connector, through the Bluetooth link, or through the cellular telephone's standard voice/data transceiver. With the application program in place in the telephone, the commands from the workload manager module can now be implemented at the cellular telephone, thus providing safety and convenience benefit to the vehicle's user. As another option to the use of a transmitter, the diagnostic connector in the vehicle can be directly connected to the multi-pin connector on the telephone (e.g., via a cable), thus alleviating the need for short-range communications between the cellular telephone and the diagnostic connector.

As noted earlier, a problem with telematics systems in vehicles is the lack of communication and control between the telematics system and other hand-held communication devices that might be present in the vehicle. Specifically, in the context of a telematics system having a workload manager module designed to mitigate or arbitrate driver distractions, this lack of communication and control reduces the effectiveness of the workload manager module, as distractions (e.g., telephone calls) can be presented to the driver's hand-held cellular telephone even when the workload manager module knows it is not optimal.

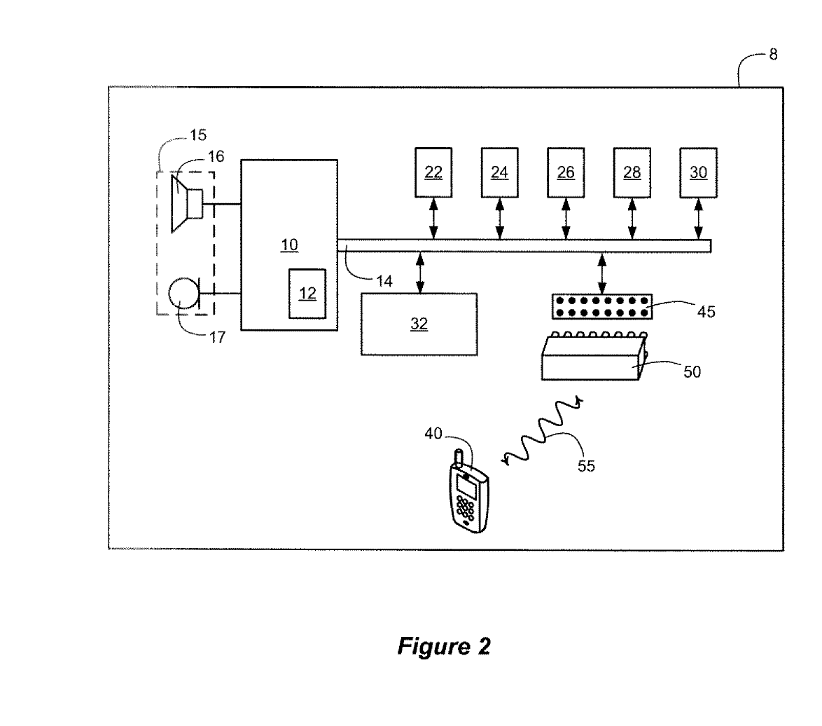

This problem is solved in one embodiment of the invention by providing a communication and control link 55 between the workload manager module 32 and the hand-held communication device 40, as shown in FIG. 2 at a high level. In an embodiment, this communication and control occurs by coupling a “dongle” 50 to the diagnostic connector 45 in the vehicle. However, before discussing the specifics of this embodiment, vehicle diagnostic systems and architectures are briefly discussed.

As is known, many present-day vehicles have OBD systems, such as ODB system 28 introduced earlier. Such OBD systems 28 can be controlled by any control device coupled to the vehicle bus 14, and can run algorithms to query various sensors on the vehicle (not shown), and to report queried data back to the control device. In this regard, a diagnostic connector 45, normally located by the driver under the vehicle's dashboard, is provided as a convenient location for connecting such a control device. For example, although not shown, in a typical diagnostic application, a vehicle needing inspection drives to a garage having authorized inspection equipment, i.e., an example of the control device just alluded to (not shown). The inspection equipment is essentially a specialized computer having a cable for coupling to the diagnostic connector 45. Once connected, the inspection equipment can send control signals to the OBD module 28, which in turn queries the sensors, etc., and returns data back to the inspection equipment via the vehicle bus 14 and through the diagnostic connector. One skilled in the art will realize that other information other than raw diagnostic information is also available on the vehicle bus 14, and hence is available through the diagnostic connector, such as a vehicle's identification number (VIN), odometer information, etc.

Standards typically govern the various designs of the diagnostic connector 45 and the protocol used with them. Currently, OBD-II connectors are mandated to be supplied with all new cars sold in the U.S. OBD-II replaced the earlier OBD-I standard, and may eventually be replaced in production vehicles by an even-newer OBD-III standard or the like. Again, vehicle diagnostics, the protocols, connector designs, etc., are all very well known to those of skill in the art. Moreover, it should be understood that the particular type of connector, or the protocol standards with which it is used, are not important to the invention, and hence the term “diagnostic connector” should be understood as generic to all such types of connector, whether in the vehicle's cabin underneath the dashboard, under the hood of the vehicle, etc.

However, the salient point with respect to the invention is not vehicle diagnostics per se, but rather realization that the diagnostic connector 45 is useful in the context of the invention as a means for “tapping into” the vehicle bus 14, and hence the workload manager module 32, which is also coupled to the vehicle bus. Assuming the cellular telephone 40 can be communicatively coupled to this diagnostic connector 45 via link 55, a mechanism can exist for allowing communication and control between the cellular telephone 40 and the workload manager module 32. This, in turn, allows the telephone 40 to be controlled by the workload manager module 32 in the vehicle 8, as is explained further below.

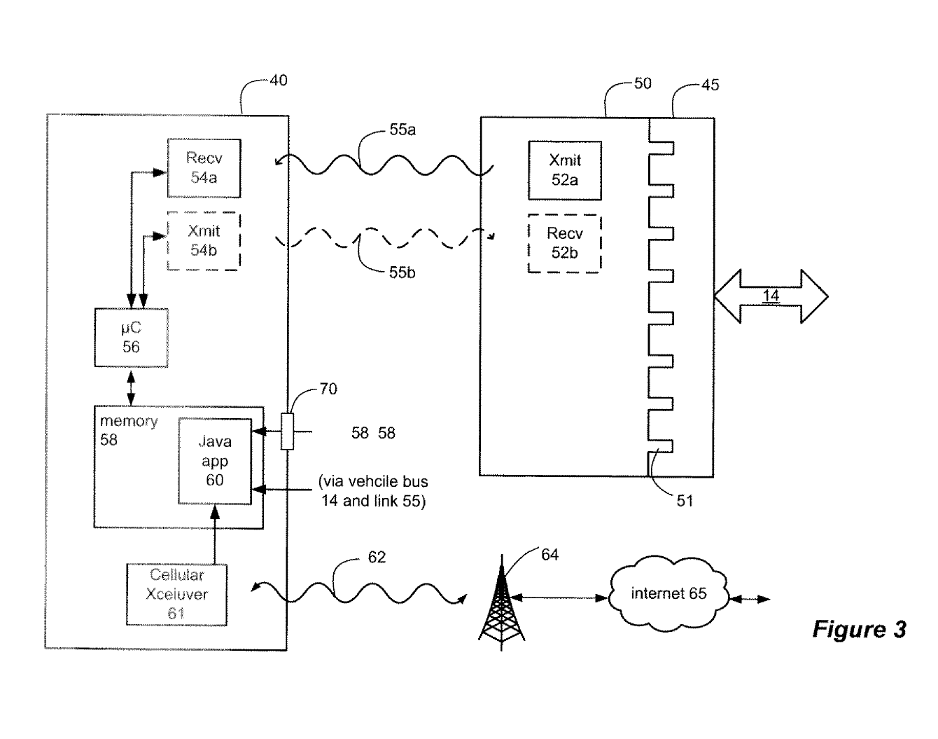

In an embodiment, communicatively coupling the diagnostic connector 45 with the cellular telephone 40 is accomplished by a dongle 50, as already mentioned. As one skilled in the art will understand, a “dongle” is a term used to denote a communication module housing which can be directly coupled to a connector (such as 45) without the use of a cable or other link. Thus, as shown, dongle 50 comprises a rigid case of any suitable composition for housing the electronics as shown in further detail in FIG. 3. In this embodiment, and as alluded to earlier, the job of the dongle is to provide a communication link 55 with the cellular telephone 40 so that commands issued by the workload manager module 32 can be sent to control the cellular telephone 40. The dongle 50 is essentially mounts directly to the diagnostic connector 45, and thus is unobtrusive to the driver of the vehicle.

In one embodiment, the communication link 55 between the dongle 50 and the cellular telephone 40 is any short-range radio communication means, such as Bluetooth, WiFi, etc. Typically, the electronics in the dongle 50 are kept as simple as possible to reduce its cost. For example, in the most minimal implementation, and referring to FIG. 3, the dongle 50 may only comprise Bluetooth transmitting circuitry 52a. (Of course, other logic might also accompany such transmitting circuitry 52a as one skilled in the art will understand, but this is not shown for convenience). Of course, this is only useful if the cellular telephone 40 is also Bluetooth compliant, and in this regard, the cellular telephone 40 must comprise Bluetooth receiver circuitry 54a, which functionality can often be added to the telephone 40 after market via a chip card (not shown) if such receiver circuitry 54a is not already present or hardwired in the telephone 40. In another embodiment, and as shown in dotted lines, two-way Bluetooth communications can be enabled to allow cellular telephone 40 to communicate back with the dongle 50 and vehicle bus 14 (i.e., via transmitting circuitry 54b in the telephone 40 and receiver circuitry 52b in the dongle 50). This two-way option is useful for example to allow the telephone to confirm the performance of commands that were sent to the telephone 40 via the dongle 50/vehicle bus 14.

The circuitry in the dongle 50 receives power to operate from power pins (such as 51) that route power and ground from the vehicle's battery or other vehicle power supply (not shown) to the dongle 50. Alternatively, the dongle 50 could contain its own replaceable or rechargeable battery (not shown).

The design of the dongle 50, from both a mechanical and circuitry standpoint, can generally be uniformly designed to serve after market users. This is possible because the design of the diagnostic connector 45 and the protocols are standardized in the marketplace. (Again, OBD-II is currently ubiquitous in vehicles in North America). This allows dongles 50 to be built as a “one size fits all” after-market solution that almost anyone could use on their vehicles. Should it be desirable to build a dongle 50 to work with many varieties of serial vehicle busses, then the dongle would contain the necessary communication physical layers to effectuate this, as one skilled in the art well understands.

Any instructions sent from the workload manager module 32 to the cellular telephone 40 through the dongle 50, however, need to be in a condition which the cellular telephone 40 can recognize and act upon. In this respect, it should be noted that the commands as sent from the vehicle (assuming they are not translated at the vehicle 8) will be issued according to the protocol operable on the vehicle bus 14. Of course, this protocol may or may not be recognizable by the cellular telephone 40.

To address this concern, in one embodiment, the telephone is provided with an application program 60 stored in memory 58 including computer program instructions for interpreting the commands as issued from the vehicle bus 14 (specifically, from the workload manager module 32) and for converting such commands to instructions executable by a microcontroller 56 of the cellular telephone 40. In one embodiment, the application program 60 comprises a Java applet, i.e., an application program written in the Java programming language. However, it should be noted that the language in which the application program 60 is written is not important to embodiments of the invention.

As one skilled in the art will understand, the application program 60 may be different for different models of cellular telephones 40, because such different models of cellular telephones may require different translations of the original vehicle bus commands. Alternatively, the application program 60 may be able to detect the type of telephone into which it is installed, and can execute appropriate routines for that telephone accordingly, which again provides a “one size fits all” solution for the telephone-side of the communication. Regardless, the goal of the application program 60 is to control the telephone in accordance with instructions issued by the workload manager module 32 in the vehicle 8.

In one embodiment, the application program 60 reacts to commands sent from the workload manager module 32 in exactly the same way that the embedded communication device 12 in the telematics unit 10 reacts. For example, if the workload manager module 32 decides on the basis of driving conditions indicated on the vehicle bus 14 that the driver is probably busy and should not be interrupted, the module 32 may instruct both the embedded device 12 and the cellular telephone 40 to not “ring” the driver, and may instruct either device to pass the attempted communication to a voice mail box. Again, the application program 60 converts these instructions in a manner understandable to the microcontroller 56 in the telephone 40.

The application program 60, like the dongle 50, is preferably easily installed in an otherwise standard cellular telephone 40 after market, although of course any of the implementations disclosed herein can also be implemented during manufacturing. In an after-market application, it is necessary to download the application program to the cellular telephone 40, where it can be stored in a non-volatile memory 58 for execution by the microcontroller 56. The application program 60 can be downloaded to the cellular telephone 40 in several different ways. For example, the program can be loaded into the telephone via a typical multi-pin connector 70 typically present on most cellular telephones 40, which might allow the program 60 to be downloaded from a service station that services the telephones 40 in question via a cable from a suitable on-site telephone programmer.

Alternatively, the application program 60 is downloaded to the telephone wirelessly, which can occur in at least two ways. First, if the application program 60 is a general program designed to work with several different models of cellular telephones 40, the program 60 may be stored in conjunction with the telematics unit 10, for example, during the installation of the telematics unit 10 in the vehicle 8. In that case, the application program 60 can be downloaded to the cellular telephone 40 via the short-range wireless Bluetooth link 55a already discussed.

Second, the application program 60 can be downloaded to the cellular telephone 40 via the longer-range transceiver circuitry 61 used to carry normal cellular communications (voice and data) to and from the cellular telephone 40. In this embodiment, and as shown in FIG. 3, the cellular telephone 40 communicates with a ground-based infrastructure, such as cellular tower 64, and possibly the internet 65 or other database (not shown) to download the necessary application program 60. If the application program 60 is to be downloaded from the internet 65, the cellular telephone 40 may include internet browser software to ultimately access a database (not shown) where the application is stored. Such internet browsers are increasingly common in modern-day cellular telephones. Such web browsing can also serve as a registration step, and can also occur using another separate computer connected to the Internet.

Regardless of how the application program 60 is downloaded to the cellular telephone 40, once locally resident in memory 58, that program 60 is executed to essentially control the cellular telephone 40 in response to commands from the workload manager model 32. It is however not strictly necessary that the embedded communication device 12 and the cellular telephone 40 be controlled exactly in the same fashion and/or in tandem. For instance, the workload manager module may issue different instructions to embedded devices 12 and external devices such as cellular telephone 40, in a manner which produces different results at these two devices. For example, the workload manager module 32 may decide that it is appropriate given certain driving conditions to allow calls to pass to the embedded device 12 (which is more easily answered, allows for hands-free operation, etc.), but not to external communication devices such as the cellular telephone 40 (which is more cumbersome to answer, requires manipulation, etc.).

Using embodiments of the disclosed invention, the workload manager module 32 is now expanded in its performance, and better able to perform it advocacy function, as it is enabled to control not just communications internal to the vehicle 8, but communications outside the vehicle as well. Thus, the results are improved driver safety, and better overall control of all communications that might be implicated in the vehicle 8.

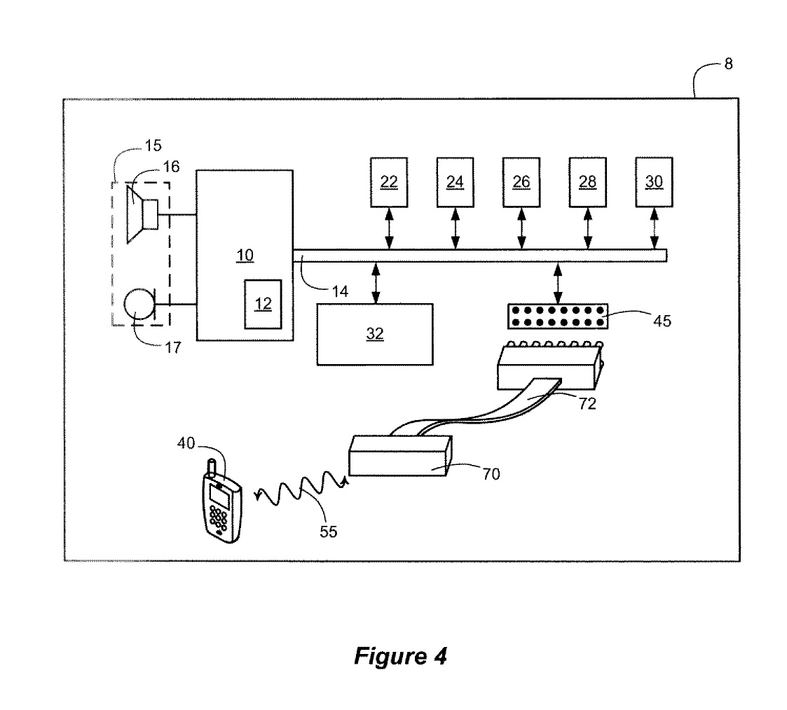

In addition to the embodiments disclosed above, other modifications are possible and are still within the spirit and scope of the invention. For example, it was earlier noted that there are benefits to the use of a dongle 50. However, it is not strictly necessary to use a dongle, i.e., a housing directly connected to connector 45 without the use of a cable or link. Instead, and as shown in FIG. 4, the electronics otherwise earlier described as housed within the dongle 50 can be placed in a housing 70, which is connected by a cable 72 to the diagnostic connector 45. In some situations, however, the cable 72 and housing may get in the driver's way. In the dongle 50 embodiment, by contrast, all relevant components are positioned proximate to the connector 45, and hence are not likely to interfere with the driver.

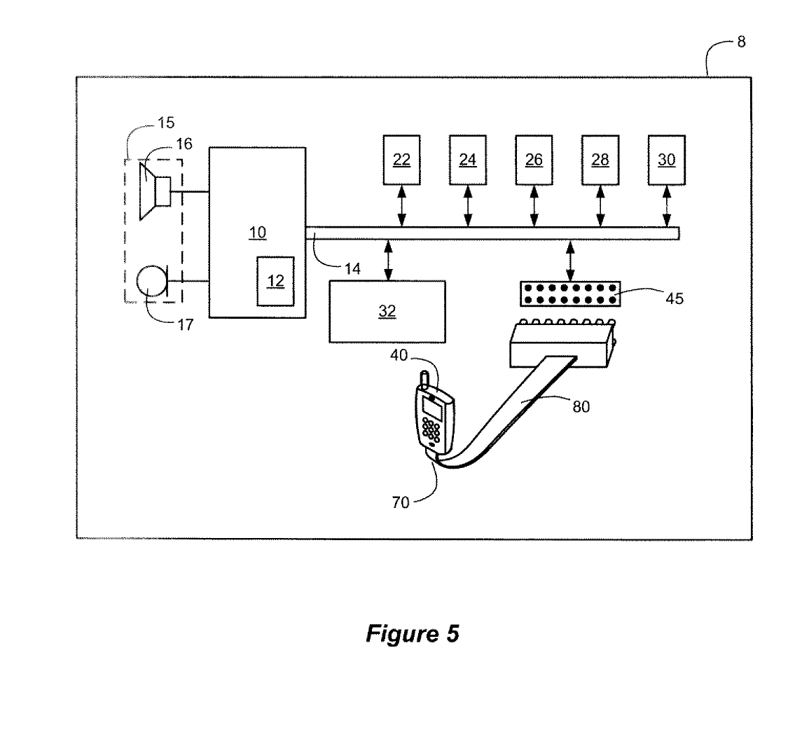

Furthermore, and as shown in FIG. 5, it is not necessary that the link 55 between the cellular telephone 40 and the connector 45 be wireless. Indeed, a cable 80 can be used to connect the multi-pin connector 70 on the cellular telephone 40 (see also FIG. 3) to the diagnostic connector 45 within the vehicle 8. This allows the invention to control the cellular telephone 40 without the necessity of localized Bluetooth communications within the vehicle 8. Of course, this also requires a hardwired cable between the two devices, which may be obtrusive to the driver.

In other useful embodiments, the user can override operation of the system to prevent the workload manager module 32 from controlling the cellular telephone 40 if desired, which might be important to the user if s/he is expecting a very important call which should not be interrupted.

Finally, it should be recognized that embodiments of the invention are directed broadly to manners for using the electronics in a vehicle to controlling a hand-free communication device. In this regard, it is not necessary that such control be directed to driver safety, or that such control originating from a safety-oriented module such as the workload manager module 32 discussed above. In short, embodiments of the invention accommodate other non-safety based commands, which commands can issue from any module in the vehicle, such as the telematics unit 10, the embedded communication device 12, any of the subsystems 20-30, etc.

As used herein, a “command” issued by a vehicle module and as received by the hand-held device includes commands as might be modified in a manner not affecting their function. For example, if a command is issued by the workload manager module, that same command is said to be received at the cellular telephone even if its form has been modified in transition. As one skilled in the art will appreciate, this recognizes that a command is not changed and rendered something else just because it has been processed on route between the module and the telephone.

It should be understood that the inventive concepts disclosed herein are capable of many modifications. To the extent such modifications fall within the scope of the appended claims and their equivalents, they are intended to be covered by this patent.

What is claimed is:

1. A method of controlling a hand-held communication device via a module in a vehicle, comprising:
issuing from the module and onto a vehicle bus at least one command for controlling the hand-held communication device;
receiving the command at a transmitter coupled to a diagnostic connector in the vehicle;
wirelessly broadcasting the command from the transmitter; and
receiving the command at a receiver in the hand-held communication device,
wherein the command is used to control the hand-held communication device.

2. The method of claim 1, wherein the diagnostic connector comprises an on-board diagnostic (OBD) connector.

3. The method of claim 1, wherein the module comprises a workload manager module for receiving signals on the vehicle bus indicative of driver stress and in response for issuing the command so as to mitigate disturbance to a driver from at least the hand-held communication device.

4. The method of claim 1, wherein the transmitter and receiver are Bluetooth or WiFi complaint.

5. The method of claim 1, wherein the transmitter is housed in a dongle coupled to the diagnostic connector.

6. The method of claim 1, further comprising using an application program within the hand-held communication device to interpret the command in a manner suitable for controlling the hand-held communication device.

7. The method of claim 1, wherein the command also controls an embedded communication device within a telematics unit of the vehicle.

8. A method of controlling a hand-held communication device via a module in a vehicle, comprising:
issuing from the module and onto a vehicle bus at least one command for controlling the hand-held communication device, wherein the module comprises a workload manager module for receiving signals on the vehicle bus indicative of driver stress and in response for issuing the command so as to mitigate disturbance to the driver from at least the hand-held communication device;
coupling the hand-held communication device to a diagnostic connector in the vehicle, wherein the diagnostic connector is coupled to the vehicle bus; and
receiving the command at a receiver in the hand-held communication device,
wherein the command is used to control the hand-held communication device.

9. The method of claim 8, wherein the diagnostic connector comprises an on-board diagnostic (OBD) connector.

10. The method of claim 8, wherein the hand-held communication device is wirelessly coupled to the diagnostic connector.

11. The method of claim 10, wherein the hand-held communication device is wirelessly coupled to the diagnostic connector via a Bluetooth or WiFi protocol.

12. The method of claim 10, wherein the hand-held communication device is wirelessly coupled to the diagnostic connector using a transmitter housed in a dongle coupled to the diagnostic connector.

13. The method of claim 8, wherein the hand-held communication device is coupled to the diagnostic connector via a cable.

14. The method of claim 8, further comprising using an application program within the hand-held communication device to interpret the command in a manner suitable for controlling the hand-held communication device.

15. The method of claim 8, wherein the command also controls an embedded communication device within a telematics unit of the vehicle.

16. A system for controlling a hand-held communication device via an electronic module in a vehicle, comprising:
a module within a vehicle and coupled to the vehicle bus, the module for controlling at least the hand-held communication device via at least one command issued onto a vehicle bus;
a diagnostic connector coupled to the vehicle bus; and
a hand-held communication device coupled to the diagnostic connector, the hand-held communication device comprising an application program for interpreting the command in a manner suitable for controlling the hand-held communication device.

17. The system of claim 16, wherein the diagnostic connector comprises an on-board diagnostic (OBD) connector.

18. The system of claim 16, wherein the hand-held communication device is wirelessly coupled to the diagnostic connector.

19. The system of claim 18, wherein the hand-held communication device is wirelessly coupled to the diagnostic connector using a transmitter housed in a dongle coupled to the diagnostic connector.

20. The system of claim 16, wherein the application program comprises a Java applet.
